(19) United States
(12) Patent Application Publication
(10) Pub. No.: US 2010/0093510 A1
(43) Pub. Date: Apr. 15, 2010

(54) GLASS COMPOSITION FOR GLASS FIBER, GLASS FIBER, PROCESS FOR PRODUCING GLASS FIBER AND COMPOSITE MATERIAL

(76) Inventors: Toshikatsu Tanaka, Shiga (JP); Hiroshi Uenishi, Shiga (JP)

Correspondence Address: KUBOVCIK & KUBOVCIK, SUITE 1105, 1215 SOUTH CLARK STREET, ARLINGTON, VA, 22202, US

(21) Appl. No.: 12/450,160

(22) PCT Filed: Mar. 12, 2008
(86) PCT No.: PCT/JP2008/054450

§ 371 Date: Sep. 14, 2009

(30) Foreign Application Priority Data
Mar. 15, 2007 (JP) 2007-066203

(51) Int. Cl. C03C 13/04; C03C 14/00; C03B 37/02

(52) U.S. Cl. 501/32; 501/37; 65/402

(57) ABSTRACT

A glass composition for glass fiber comprises, by mass percentage in terms of oxide, 60 to 75% SiO₂, 0 to 10% Al₂O₃, 0 to 20% B₂O₃, 5 to 15% Li₂O+Na₂O+K₂O, 0 to 10% MgO+CaO+SrO+BaO+ZnO, 0 to 10% TiO₂ and 0 to 10% Zr0₂. A glass fiber consists of the above glass composition for glass fiber. A process for producing a glass fiber comprises the steps of melting the above glass composition in a heat-resistant vessel and continuously drawing out the molten glass through a heat-resistant nozzle so as to form a glass fiber; coating the surface thereof with a chemical; and continuously reeling the coated glass fiber. A composite material is obtained by compositing the glass fiber with an organic resin.

### TECHNICAL FIELD

The present invention relates to a glass composition for glass fiber which is useful as a constitutive component of a composite material that is transparent to a visible light, a glass fiber, a process for producing a glass fiber and a composite material.

### BACKGROUND ART

Glass fibers utilized for constituting a variety of composite materials not only have good mechanical properties such as strength and elasticity, but also show excellent fire-retardant and lightweight properties when they are formulated into composite materials. Hence, they have achieved wide use in many applications, including structural and functional materials for which various performances are required. Even in limited fields of information and electronic industries that are expected to carry a next generation, glass fibers have been essentials in uses such as printed circuit board, insulation sheet, IC substrate, various terminal strips, and housing material for electronic devices such as electronic parts. In the production of such glass fibers, continuous forming and spinning operations are generally carried out using a forming device, called a bushing (also referred to as a platinum heating container), which is made of a noble metal and has a generally rectangular appearance and heat resistance. This bushing is constructed in a vessel-like configuration that serves to permit a molten glass to dwell therein. This heat-resisting container has a number of vertical nozzles located at its bottom. After having been brought to a homogeneous state in a glass-melting furnace, the molten glass in the container is controlled at a temperature in the vicinity of a forming temperature (also called a spinning temperature) that corresponds to its high-temperature viscosity of 10³ dpa·s and then drawn through the heat-resisting nozzles to form glass fibers.

Glass fibers and organic resin materials can be combined into a composite material capable of transmitting a visible light by matching an Abbe number and a refractive index of the glass fibers with those of the transparent organic resin materials. A representing use of such a transparent composite material is as a composite material for an image display substrate. A number of inventions have been practiced for this purpose.

For example, Patent Document 1 discloses an invention which combines glass fibers having a refractive index of 1.45-1.55 with the corresponding resin to formulate a transparent composite composition having an Abbe number of not less than 45. Patent Document 2 discloses an invention which uses, as a component of a transparent composite material, an epoxy resin which has a refractive index that falls within 0.01 from that of a glass filler, a low expansion coefficient and a purity of at least 85% as determined from an oxirane oxygen content. Patent Documents 3 and 4 disclose glass fiber compositions which have a refractive index that falls within 0.001 from that of a polycarbonate resin. Patent Document 5 discloses a glass fiber thermoplastic resin composite having improved transparency, coloring and surface appearance, which contains a specific proportion of a glass fiber and a resin such as aromatic polycarbonate. Patent Document 6 discloses a resin sheet useful for a display device substrate, which comprises a cloth-like structure made of a glass fiber and a resin having a haze value of not exceeding 10%, with a refractive index difference of 0.01. Patent Document 7 discloses an invention which provides a transparent composite sheet, as an alternative of a glass substrate, by stacking glass fibers so as for them to orient with an axial deviation of 10 degrees-80 degrees.
Patent Document 1: Japanese Patent Laid-open No. 2004-231934
Patent Document 2: Japanese Patent Laid-open No. 2006-176586
Patent Document 3: Japanese Patent Laid-open No. 2006-22235
Patent Document 4: Japanese Patent Laid-open No. 2006-22236
Patent Document 5: Japanese Patent Laid-open No. 2006-348299
Patent Document 6: Japanese Patent Laid-open No. 2005-156840
Patent Document 7: Japanese Patent Laid-open No. 2005-297312

### DISCLOSURE OF THE INVENTION

However, the inventions as proposed heretofore, if alone, have been insufficient to realize a glass fiber which has adequate mechanical properties and exhibits diverse optical performances, which can suppress the occurrence of glass defect such as devitrification, which has such an excellent quality level of appearance that results in achievement of high performances, and which can be efficiently produced. Accordingly, there remain problems to be solved.

That is, if a composite material is to exhibit a high optical quality, it must have a visible light transmittance commensurate therewith. However, none of composite materials as provided heretofore by combining a glass fiber and an organic resin achieves a high visible light transmittance at a wavelength in the approximate range from 340 nm to 800 nm. Although possible to realize a high transmittance of a visible light at a specific wavelength, they scarcely transmit a visible light at the other wavelength and accordingly appear colored, which has been a problem. A composite material in this application, even if in the form of a thinner sheet than conventional, is still required to have sufficiently high mechanical strength properties. However, the effort to bring its optical properties to proper values eases precipitation of a crystal in a molten glass during production of glass fibers. Inclusion of a crystalline foreign substance in the formed glass fibers causes devitrification in the glass fiber product and accordingly lowers a production efficiency of glass fibers, which has been another problem.

The inventors of this application have noticed that the successful reduction of various glass defects in the molten glass during glass fiber production enables stable production of glass fibers and thus leads to efficient production of defect-free high-quality glass fibers for composite material, whereby such glass fibers when utilized as a composite material component can impart not only high optical properties but also high strength properties to the resulting composite material.

None of the aforementioned Patent Documents 1, 2, 5, 6 and 7 pays attention to various properties or material types of glass fibers. For example, the S glass described in Patent Document 1 certainly has desired values for refractive index and Abbe number. However, it has achieved enhanced strength by incorporating at least 20% by mass of Al₂O₃. This in most cases adversely affects melt properties of a glass. Accordingly, its production efficiency is not very high. Patent Document 2 also lists types of existing glass fiber materials, i.e., E glass, T glass, C glass and A glass. However, these are not suited for the invention of this application. Patent Documents 3 and 4 are concerned with glass fiber materials but focused on their compatibility with polycarbonate. No consideration is given to more other transparent resin materials in combination with those materials.

After the extensive research on the above-described problems, it is an object of the present invention to provide a glass composition for glass fiber which is highly matched in optical constants with a transparent resin having a refractive index of 1.47-1.56, such as an epoxy, cyclic olefin or acrylic resin, which has a high affinity for a resin and good adhesion and which shows superior melt properties, spinnability and chemical durability during a glass production process; a glass fiber; a process for producing the glass fiber; and a composite material using the glass fiber.

The glass composition for glass fiber, in accordance with the present invention, is characterized as comprising, by mass in terms of oxide, 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO₂ and 0-10% of ZrO₂.

The glass composition for glass fiber, in accordance with the preferred embodiment of the present invention, is characterized as comprising, by mass in terms of oxide, 60-75% of SiO₂, 0-10% of Al₂O₃, 0-20% of B₂O₃, 0-9% of Na₂O, 5-14% of Li₂O+Na₂O+K₂O, 0-10% of MgO+CaO+SrO+BaO+ZnO, 0-10% of TiO₂ and 0-5% of ZrO₂.

The glass composition for glass fiber, in accordance with the more preferred embodiment of the present invention, is characterized as comprising, by mass in terms of oxide, 60-75% of SiO₂, 0-10% of Al₂O₃, 0-20% of B₂O₃, 0-9% of Na₂O, 5-14% of Li₂O+Na₂O+K₂O, 0-8% of MgO+CaO+SrO+BaO+ZnO, 0-10% of TiO₂ and 0-5% of ZrO₂.

By the glass composition comprising, by mass in terms of oxide, 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO₂ and 0-10% of ZrO₂, or comprising, by mass in terms of oxide, 60-75% of SiO₂, 0-10% of Al₂O₃, 0-20% of B₂O₃, 0-9% of Na₂O, 5-14% of Li₂O+Na₂O+K₂O, 0-10% of MgO+CaO+SrO+BaO+ZnO, 0-10% of TiO₂ and 0-5% of ZrO₂, or comprising, by mass in terms of oxide, 60-75% of SiO₂, 0-10% of Al₂O₃, 0-20% of B₂O₃, 0-9% of Na₂O, 5-14% of Li₂O+Na₂O+K₂O, 0-8% of MgO+CaO+SrO+BaO+ZnO, 0-10% of TiO₂ and 0-5% of ZrO₂, it is meant the following.

That is, it is meant that, when the glass-constituting elemental components are each expressed in terms of oxide by using various measuring means such as chemical analysis and instrumental analysis, an SiO₂ component is in the range of 60-75% by mass, an Al₂O₃ component is not greater than 10% by mass, an B₂O₃ component is not greater than 20% by mass, a total amount of an Li₂O component, an Na₂O component and a K₂O component is in the range from 5% by mass to 15% by mass, a total amount of 5 components, i.e., a total amount of MgO, CaO, SrO, BaO and ZnO components is not greater than 10% by mass, a TiO₂ component is not greater than 10% by mass, and a ZrO₂ component is not greater than 10% by mass.

In the preferred embodiment of the present invention, the Na₂O component is not greater than 9% by mass, a total amount of the Li₂O, Na₂O and K₂O components is from 5% by mass to 14% by mass, and the ZrO₂ component is in the range of not exceeding 5% by mass. In the more preferred embodiment of the present invention, a total amount of the 5 components, i.e., MgO, CaO, SrO, BaO and ZnO components, is not greater than 8% by mass.

The reason for which each constitutive component of the glass composition of the present invention is contained in the amount specified above is now described specifically.

The SiO₂ component is a skeleton component of a glass structure and accordingly is a main constitutive component of the glass composition of the present invention. The strength of the glass structure tends to increase with increase in the content of the SiO₂ component in the glass composition. On the other hand, the increase in content of the SiO₂ component in the glass composition increases a high-temperature viscosity value of a molten glass and accordingly makes it difficult to form a glass. As a result, if such a glass composition is to be homogeneously conditioned by a melting process, expensive facilities must be installed. In some cases, limitation may be imposed on the facility control during glass production. In order that the strength of the glass structure is maintained in a sufficient condition and is rendered high, it is necessary that the content of the SiO₂ component is at least 60% by mass, more preferably at least 63% by mass. On the other hand, in order to assure a productivity of glass fibers by insuring high processability and rendering it unnecessary to apply an excessive thermal energy in melting a glass, it is necessary that the content of the SiO₂ component does not exceed 75% by mass.

The Al₂O₃ component is a component which is effective in realizing chemical and mechanical stability of a glass. If it is contained in a glass by a proper amount, precipitation of a crystal in a molten glass is effectively prevented. On the other hand, excessive inclusion thereof increases a viscosity of the molten glass. It is accordingly necessary that the content of the Al₂O₃ component in the glass composition does not exceed 10% by mass. The Al₂O₃ component also increases an elastic modulus of a glass. The higher content of the Al₂O₃ component increases the difficulty of the formed glass to deform when an external force is applied thereto. Accordingly, in order to maintain a molten glass in a condition suitable for spinning of glass fibers and sufficiently obtain a crystallization preventing effect as well as an elastic modulus increasing effect, it is preferred that the content of the Al₂O₃ component is at least 1% by mass.

The B₂O₃ component is a skeleton component of a glass structure, as similar to the SiO₂ component. Unlike the SiO₂ component, it does not increase a high-temperature viscosity of a molten glass but rather acts to lower the high-temperature viscosity of a molten glass. However, the excessively high content of the B₂O₃ component in the glass composition increases a vaporization of the B₂O₃ component from a molten glass, resulting in the difficulty to maintain the molten glass in a homogeneous condition. Also, the higher content of the B₂O₃ component increases the tendency of a glass to undergo phase separation. The occurrence of phase separation is not desirable because it in some cases impairs chemical durability or optical properties. From this point of view, it is necessary that the content of the B₂O₃ component in the glass composition does not exceed 20% by mass. Also, in order for the B₂O₃ component to enhance its effect to lower the high-temperature viscosity of a molten glass while maintaining the strength of the glass structure as a skeleton component thereof, it is preferred that the content of the B₂O₃ component in the glass composition does not fall below 3% by mass.

The TiO₂ component is a component which, if increased in content in the glass composition, increases a refractive index (nd) that is an optical constant of a glass and lowers an Abbe number (νd) that is another optical constant. Also, in the case where the glass composition contains an alkali metal element, the TiO₂ component is in some cases effective in restraining the amount of alkali elution. So long as such effects are remarkable, the content of the TiO₂ component is more preferably at least 0.1% by mass, further preferably at least 0.3% by mass, further more preferably at least 0.5% by mass, most preferably at least 1.0% by mass. Also, the TiO₂ component is an effective component to properly control the refractive index and Abbe number by its loading. However, the increased content of the TiO₂ component in the glass composition sometimes increases a refractive index of the glass excessively. The increased content of the TiO₂ component in the glass composition also increases a tendency of a crystal containing titanium (Ti) to precipitate in the glass melt and further increases the occurrence of phase separation that increases a tendency of a crystal containing silicon (Si) to precipitate in the glass melt. In either case, devitrification develops in the molten glass to hinder production of homogeneous glass. Also, the increased content of the TiO₂ component in the glass may color the glass for some glass compositions, which is not desirable. From these standpoints, in order that a stable glass composition is provided which has an Abbe number (νd) approximate to that of a transparent resin material to be combined with the glass into a composite material and which restrains development of devitrification and causes no problem on coloring, it is necessary that the content of the TiO₂ component in the glass composition does not exceed 10% by mass.

The ZrO₂ component is a component which acts to increase a refractive index (nd) of a glass and lowers an Abbe number (νd), as similar to the aforementioned TiO₂ component, but does not color the glass, as contrary to the TiO₂ component. However, an increase in content of the ZrO₂ component in the glass composition tends to ease precipitation of a crystal containing zirconium (Zr) in a molten glass and hinder spinning of glass fibers due to devitrification. Accordingly, in order to adjust optical constants of the glass fibers, such as a refractive index, to proper values relative to the transparent resin material as well as to hinder devitrification so that production of stable glass fibers can be achieved, an upper limit in content of the ZrO₂ component in the glass composition is set at 10% by mass. That is, it is necessary that the content of the ZrO₂ component in the glass composition does not to exceed 10% by mass. More preferably, it is maintained not to exceed 5% by mass.

The alkali metal oxide represented by the Li₂O, Na₂O and K₂O components and expressed in terms of oxide in the glass composition serves as a so-called flux to ease formation of a glass melt as plural glass raw materials in a mixed condition are rendered into the glass melt by heating. The alkali metal oxide component, if TiO₂ content in the glass composition is high, also serves to restrain the occurrence of devitrification in the glass melt. However, undesirable results occur where the alkali metal oxide content becomes too high. The excessively high content of the alkali metal oxide component in the glass composition in some cases inhibits curing of the transparent resin as it is combined with the glass fiber into a composite material. Also in this case, after the glass fiber and transparent resin are combined into a composite material, the bond strength at an interface between them decreases with time due to the effect of the alkali metal element in the glass composition. This reduces a strength of the composite material and accordingly lowers its reliability as a structural material. Also, if the content of the alkali metal oxide component in the glass composition increases, a refractive index of the glass may become too high, which is not desirable. From these standpoints, if the total content of the Li₂O, Na₂O and K₂O components, expressed in % by mass, is maintained not to fall below 5%, these components act sufficiently as a flux to promote melting of the glass and improve an efficiency of glass production. Also, they exhibit a remarkable action to adjust a refractive index of the glass to a proper value and remedy a tendency of the glass having a high TiO₂ content toward devitrification. On the other hand, if the total content of the Li₂O, Na₂O and K₂O components, expressed in % by mass, is maintained not to exceed 15%, combining the glass fibers with transparent resin results in the formation of a composite material which has a proper refractive index value. Also, the transparent resin is not hindered from curing as the composite material is formed.

As a result, transparency and strength of the formed transparent composite material can be stabilized. From such standpoints, in order for the composite material to exhibit stable performances, it is desirable that the total content of the Li₂O, Na₂O and K₂O components, expressed in % by mass, is more preferably maintained not to exceed 14% by mass.

Also because the Na₂O component, among the alkali metal oxides, has a higher likelihood of leaching out from a glass surface, leach out thereof, if occurs, may adversely affect adhesion between the resin and glass fiber when combined to form the composite material. It is accordingly desirable that the content of the Na₂O component is preferably maintained not to exceed 9% by mass. If the content of the Na₂O component is kept within 9% by mass, the amount of the alkali component that leaches out from a glass surface can be reduced. The occurrence of a problem regarding adhesion at an interface between the resin and the glass fiber can also be reduced.

The five components expressed as divalent oxides, i.e., MgO, CaO, SrO, BaO and ZnO components, all act as a flux to promote melting of a glass raw material and ease melting of a glass, although their actions are not so effective as the preceding alkali metal oxides. They are also effective in adjusting the optical constants, such as a refractive index and an Abbe number, to proper levels. On the other hand, the excessively high contents thereof undesirably increase the tendency of crystals containing these components to precipitate. Also undesirably, the refractive index (nd) of the glass becomes too high. From these standpoints, it is necessary that the total content of the MgO, CaO, SrO, BaO and ZnO components is maintained not to exceed 10% by mass, more preferably 8% by mass.

Also, the ZnO component, if used for the glass composition containing an alkali metal element, is in some cases effective in reducing the amount of alkali elution. So long as such an effect is remarkable, it is desirable that the content of the ZnO component is more preferably at least 0.1% by mass, further preferably at least 0.3% by mass, still further preferably at least 0.5% by mass.

When necessary, various other components can also be added to the glass composition of the present invention within the range that does not impose significant influences on the properties of the glass composition, such as optical constants, chemical durability and viscosity. Specific examples of components useful for addition to the glass composition of the present invention include P₂O₅, Fe₂O₃, Cr₂O₃, Sb₂O₃, As₂O₃, SO₂, Cl₂, F₂, PbO, La₂O₃, WO₃, Nb₂O₅, Y₂O₃, MoO₃ and CeO₂. Any of these rare-earth oxides may be contained in the glass composition of the present invention, so long as its content does not exceed 3% by mass.

Among these additives, Fe₂O₃ is preferably contained in a smaller amount, particularly when a higher transmittance is needed. An upper limit of its amount is preferably not greater than 1%, expressed in % by mass in terms of oxide.

Other than the above components, a small-scale component can also be contained up to 0.1% by mass, examples of which include OH, H₂, CO₂, CO, H₂O, He, Ne, Ar and N₂.

The glass composition for glass fiber, in accordance with the present invention, may further contain a trace amount of a noble metal element, unless it has a significant effect on properties of the glass composition. For example, a platinum group element such as Pt, Rh or Os may be contained up to 1,000 ppm.

The glass composition for glass fiber, in accordance with the present invention, can provide glass fibers resulting in the composite material which has a high visible light transmittance and causes no coloring issues, provided that in addition to satisfying the above, it has optical constants represented by a refractive index (nd) in the range of 1.48-1.55 and an Abbe number (νd) in the range of 65-50.

By having optical constants represented by a refractive index (nd) in the range of 1.48-1.55 and an Abbe number (νd) in the range of 65-50, as described herein, it is meant that the glass shows a refractive index in the range from 1.48 to 1.55 relative to a spectral line (D line) at a wavelength of 587.56 nm from an He light source as well as it shows a value within the range from 65 to 50 for an Abbe number (νd) when determined by subtracting a refractive index (nC) relative to a spectral line (C line) at a wavelength of 656.27 nm from an H light source from a refractive index (nF) relative to a spectral line (F line) at a wavelength of 486.13 nm from an H light source to give a denominator, subtracting 1 from the refractive index (nd) to give a numerator and calculating the fraction, i.e., when defined by (nd−1)/(nF−nC).

If the refractive index (nd) of the glass is lower than 1.48, the refractive index of the glass fiber becomes much lower than that of a transparent resin such as an epoxy, acrylic or cyclic olefin resin. This is not desirable because even if these transparent resins are combined with such glass fiber, a visible light incident on the transparent resin does not advance straight but is scattered to reduce translucency, resulting in the failure to form a colorless, transparent composite material. On the other hand, if the refractive index (nd) is higher than 1.55, it becomes difficult to match an Abbe number of the glass fiber with that of the transparent resin. Due to a large difference in Abbe number between the glass fiber and transparent resin, the resulting composite material is made either opaque or colored blue, red or purple if transparent. In order that the glass exhibits the above-specified refractive index at a wavelength of 587.56 nm as well as achieves transmission of a light at wavelengths in the visible region, the Abbe number (νd) must fall within the specified range. If its value is in the range from 65 to 50, a composite material can be formed which has a sufficiently high visible light transmittance. If the Abbe number (νd) falls below 50 or exceeds 65, a difference in Abbe number between the glass fiber and transparent resin becomes large so that the composite material using such glass fibers is made opaque or colored blue, red or purple if transparent.

Measurement of refractive index can be achieved by using an instrument according to a measuring method such as a V-block method which has been inspected by a standard sample and found capable of determining a refractive index down to a fifth decimal place. The Abbe number can be calculated from the refractive index values obtained via measurement with a D light source, a F light source and a C light source.

The glass composition for glass fiber, in accordance with the present invention, can be used in combination with a transparent resin material to provide a composite material which has a high transmittance in a shorter wavelength range in the higher visible region, provided that in addition to satisfying the above, it exhibits a transmittance at 350 nm of at least 70% at a thickness of 1.0 mm. In the case where glass fibers made from this glass composition for glass fiber are used to constitute a composite material, no color-causing absorption is observed in a transmittance in the shorter wavelength range, so that the composite material is not colored.

By the glass composition exhibiting a transmittance at 350 nm of at least 70% at a thickness of 1.0 mm, it is meant that the glass composition exhibits a transmittance of at least 70% when subjected to a sequence of melting and quenching to obtain a glass mass, mirror polishing a glass mass into a 1.0 mm thick sheet glass and then measuring a transmittance for the sheet glass by a spectrophotometer.

Provided that in addition to the above, a ratio of a transmittance at 750 nm to a transmittance at 350 nm (hereinafter referred to as 750 standard transmittance ratio) is 0.8-1.2, the glass composition for glass fiber, in accordance with the present invention, has a stable and high transmittance because its transmittance at 350 nm little varies from its transmittance at 750 nm. Accordingly, a colorless and stably transparent composite material can be obtained.

Provided that in addition to the above, a ratio of a transmittance at 550 nm to a transmittance at 350 nm (hereinafter referred to as 550 standard transmittance ratio) is 0.8-1.2, the glass composition for glass fiber, in accordance with the present invention, can provide a composite material having a further stable transmittance property because its transmittance at 350 nm little varies from its transmittance at 550 nm that indicates a value at around a center of a visible wavelength region.

Provided that in addition to the above, an amount (ΣR₂O) of alkali elution according to JIS R 3502 (1995) is not greater than 0.35 mg, alkali ions in the glass in the process of being combined with a transparent resin are restrained from moving toward a surface layer of the glass fiber during a heat treatment and acting to reduce adhesion at an interface between the glass fiber surface layer and the resin. Also, a composite material can be produced which is sufficiently durable in terms of mechanical and optical properties and chemical resistance.

By the amount (ΣR₂O) of alkali elution according to JIS R 3502 (1995) of not greater than 0.35 mg, it is meant that when the glass composition of the present invention is subjected to a test according to R 3502 specified in Japan Industrial Standard, issued in 1995, and measured for the amount of alkali elution therefrom, the measurement value does not exceed 3.5 mg. For a quality level that achieves more stable chemical durability, it is more preferred that the amount of alkali extracted from the glass composition is not greater than 0.30 mg.

Provided that in addition to the above, a forming temperature (Tx) corresponding to the 10³ dPa·s viscosity of a molten glass is not greater than 1,400° C., the glass composition for glass fiber in accordance with the present invention results in obtaining a homogeneous molten glass and can provide glass fibers which little suffer various glass defects when melted.

By the forming temperature (Tx) corresponding to the 10³ dPa·s viscosity of a molten glass of not greater than 1,400° C., it is meant that a temperature at which the molten glass exhibits a viscosity of 1,000 poise does not exceed 1,400° C.

If the forming temperature (Tx) corresponding to the 10³ dPa·s viscosity of a molten glass exceeds 1,400° C., it may become difficult to control spinning conditions. In addition, a service life of facilities for glass production may be shortened to raise a production cost. These problems are not desirable.

The forming temperature (Tx) corresponding to the 10³ dPa·s viscosity of a molten glass can be determined as by using a method which determines a glass viscosity by measuring a resistance produced when a platinum ball immersed in a glass melt is pulled up from the glass melt.

If the glass composition for glass fiber in accordance with the present invention exhibits a liquidus temperature (Ty) of not higher than 1,300° C., in addition to satisfying the above, the occurrence of devitrification due to precipitation of a crystal that hinders production of glass fibers is suppressed, so that the incidence of defectives in the production of glass fibers can be reduced significantly.

By the liquidus temperature (Ty) of not higher than 1,300° C., it is meant that when the glass composition of the present invention in a molten state is cooled, a specific crystal phase is produced as a primary phase in the molten glass at a temperature of not higher than 1,300° C.

The liquidus temperature (Ty) can be determined by introducing finely-divided glass in a heat-resisting container where it is maintained at a specific temperature for 16 hours and then observing the presence of a crystal phase in the glass with optical apparatus such as a polarization microscope.

Provided that in addition to the above, a temperature difference (ΔTxy) between the forming temperature (Tx) and the liquidus temperature (Ty) is at least 70° C. for the glass composition for glass fiber in accordance with the present invention, minute crystals responsible for devitrification become difficult to precipitate in a molten glass at or near a bushing nozzle during production of glass fibers. Then, the bushing nozzle can be prevented from being plugged with such crystals, so that the cause of breakage or cutting of glass fibers, called break, can be suppressed.

In order to increase the difference (ΔTxy=Tx−Ty) between the liquidus temperature (Ty) of the molten glass and the forming temperature (Tx) in the spinning as much as possible, the spinning temperature Tx may be increased. However, that is not desirable because of the following problems: a rise of an energy required for melting increases a production cost; and a service life of a supplementary equipment such as a bushing equipment is shortened. It is accordingly desirable that the forming temperature Tx has an upper limit, the temperature difference (ΔTxy) is larger and the forming temperature Tx is lower.

The glass fiber of the present invention is characterized as comprising the aforesaid glass composition for glass fiber in accordance with the present invention.

By comprising the aforesaid glass composition for glass fiber in accordance with the present invention, it is meant that the glass composition comprises 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO₂ and 0-10% of ZrO₂, or comprises 60-75% of SiO₂, 0-10% of Al₂O₃, 0-20% of B₂O₃, 0-9% of Na₂O, 5-14% of Li₂O+Na₂O+K₂O, 0-10% of MgO+CaO+SrO+BaO+ZnO, 0-10% of TiO₂ and 0-5% of ZrO₂, or comprises 60-75% of SiO₂, 0-10% of Al₂O₃, 0-20% of B₂O₃, 0-9% of Na₂O, 5-14% of Li₂O+Na₂O+K₂O, 0-8% of MgO+CaO+SrO+BaO+ZnO, 0-10% of TiO₂ and 0-5% of ZrO₂, all the percentages being by mass in terms of oxide.

Because the glass fiber of the present invention comprises the aforesaid glass composition for glass fiber, it has optical constants, such as a refractive index, approximate to those of a transparent resin as well as exhibits superior chemical durability. Accordingly, it when combined with a transparent resin provides a product having an optical quality that is higher than conventional and little varies with time.

So long as the glass fiber obtained from the glass composition for glass fiber in accordance with the present invention has a fibrous configuration, its length, diameter and sectional shape are not particularly limited. Glass fibers may have various length dimensions, including particulate fibers such as milled fibers, short fibers such as chopped strand fibers, and long fibers such as yarns and roving fibers. The diameter of the glass fiber may range from the order of angstroms to the order of microns. The sectional shape of the glass fiber may be approximately circular, if not round, flat, rectangular or polygonal.

In addition to the above, the glass fiber of the present invention may be subjected to a heat treatment, if necessary, to adjust its refractive index. This heat treatment may be accompanied by an ion exchange treatment to strengthen the glass fiber while adjusting its refractive index.

The glass fiber of the present invention may contain minute crystals, unless they affect performances or uses of the glass fiber.

Any method can be utilized to produce the glass fiber of the present invention, so long as it can provide glass fibers having desired properties. That is, such a production method may involve various forming methods such as a direct forming method (DM method: direct-melt method) and an indirect forming method (MM method: marble-melt method).

The process for producing a glass fiber, in accordance with the present invention, is characterized as including the steps of melting the aforesaid glass composition of the present invention in a heat-resisting container and then continuously drawing a molten glass through a heat-resisting nozzle to thereby form a glass fiber, coating a surface of the glass fiber with an agent, and continuously winding up the coated glass fiber in a roll configuration.

By including the steps of melting the glass composition of the present invention in a heat-resisting container and then continuously drawing a molten glass through a heat-resisting nozzle to thereby form a glass fiber, coating a surface of the glass fiber with an agent, and continuously winding up the coated glass fiber in a roll configuration, it is meant the following. That is, the process includes, in sequence, a step in which a raw material batch consisting of a mixture of plural glass components is melted by heating in a heat-resisting container, made as of a ceramic or platinum alloy, into a homogeneous molten glass, this molten glass is adjusted to a temperature suitable for spinning and then continuously drawn from a heat-resisting nozzle disposed at a bushing so that it is quenched into a glass fiber having a predetermined size, a step in which a surface of the glass fiber is coated with a liquid-form agent by using an applicator, and a step in which a predetermined length of the glass fiber coated at its surface with a agent, such as a sizing agent, is wound around a paper tube, a bobbin or the like into a roll configuration.

The type of the agent to be coated on the glass fiber surface may be suitably selected depending on the particular end use. Specific examples of agents include sizing agents, antistatic agents, surface active agents, polymerization initiators, polymerization inhibitors, film-formers, coupling agents and lubricants.

The process for producing a glass fiber, in accordance with the present invention, which goes through the aforesaid steps in producing a glass fiber, can produce various glass fibers with more stable quality levels by following various production control techniques that have been accumulated heretofore in the production of glass fibers and further developing those techniques.

The composite material of the present invention is characterized in that it is obtained by combining the glass fiber with an organic resin material.

The composite material obtained by combining the glass fiber of the present invention with an organic resin material, as described herein, refers to a composite material which is made by combining the glass fiber of the present invention with various transparent, organic resin materials. More preferably, this composite material is a so-called, visible light transmitting composite material which exhibits a high visible light transmittance performance. By exhibiting a high visible light transmittance performance, it is meant that the composite material transmits at least 70% of a visible light having wavelengths ranging from 400 nm to 700 nm. Because the glass fiber of the present invention has a glass composition comprising 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO₂ and 0-10% of ZrO₂ or the glass composition as recited in claim 2 or the glass composition as recited in claim 3, a refractive index (nd) in the range of 1.48-1.55 and an Abbe number (νd) in the range of 65-50, a composite material transparent to a visible light can be formed by selecting a visible light transmitting organic resin material which has properties close to such optical constants of the glass fiber and combining a specific proportion of the glass fiber and the organic resin material by a proper method.

The organic resin material is not particularly limited, so long as it has desired optical properties commensurate with the end use and the like, as well as other properties required for the above-described visible light transmitting composite material, such as mechanical strength and chemical durability.

Examples of useful organic resin materials include cyclic olefin resin (nd 1.50-1.54), epoxy resin (nd 1.51-1.61), acrylic resin (nd 1.53-1.56), polycarbonate resin (nd 1.55-1.59), urea resin (nd 1.50-1.54), polyester-alkyd resin (nd 1.52-1.55), allyl resin (nd 1.50-1.575) and urethane resin (nd 1.50-1.60). In particular, the cyclic olefin resin, acrylic resin, polycarbonate resin and epoxy resin are preferred from the standpoints of optical properties, strength properties, moldability and processability. Among them, the cyclic olefin resin is most preferred because it has superior heat resistance, strength and elastic modulus and exhibits a low birefringence due to exclusion of a polar group.

The structure and form of the glass fiber to be combined with the organic resin material are not particularly specified, so long as they allow the glass fiber to exhibit desired optical performances and achieve a forming efficiency commensurate with the end use of the above-described visible light transmitting composite material to be formed. That is, the glass fiber may be directly fed to a liquid-form resin, or alternatively, mixed with a powder-form resin before the resin is softened by heating. That is, the glass fiber may be in the form of a chopped strand, yarn, roving, woven sheet, cloth, tape, nonwoven laminate or braided cloth.

A solid-form or liquid-form additive, other than the above, can be added to the composite material of the present invention in a suitable amount, when necessary, to improve the required performance. The forming properties of the composite material itself can be improved. Also, various properties of a visible light transmitting composite material, if formed, can be intentionally altered, including optical properties, surface properties, mechanical properties, electromagnetic properties and chemical durability.

Examples of useful solid-form additives include carbon fiber, ceramic powder, ceramic fiber, organic resin fiber, organic resin powder and silicone powder. Examples of useful liquid-form additives include polymerization promoter, polymerization inhibitor, antioxidant, decomposition reaction inhibitor, diluent, antistatic agent, anticoagulant, modifier, wetting agent, drying agent, mildew proofing agent, dispersant, cure promoter, reaction accelerator, thickener and reaction promoter.

In the case of the visible light transmitting composite material, a film or coating may be applied to a surface of the composite material of the present invention to improve its optical or mechanical properties. The material type of the film or coating is not particularly limited, so long as it provides an affinity for the visible light transmitting composite material and exhibits a predetermined performance.

The composite material of the present invention is suitable for uses where a high transmittance is demanded and a flat material is used having high strength and toughness and a low expansion coefficient, and is applicable for various uses including automobile-mounted articles such as automobile window panels, indicator panels and head-light coverings; constructional materials such as safety windows, soundproof Windows, light-controlling windows, crime-preventive windows, partition plates, light-transmitting roofings, plates for tent, wall surface materials and wall materials for greenhouse; electronic parts such as electronic paper substrates, optical disks, see-through substrates and substrates for various display substrates including liquid crystal displays, organic EL, color filters and LED displays; and daily articles such as lamp shades, light-screening plates and light-controlling materials.

More specific embodiments for the preceding various uses are below described.

The use of the visible light transmitting composite material for automobile-mounted articles eliminates the need of using a laminated glass as conventional. This not only lowers a cost but also allows thickness reduction. The latter enables weight reduction that contributes to reduction of CO₂ emissions.

In constructional uses, the visible light transmitting composite material is useful in application where high levels of security and flame retardancy are demanded, such as partition windows and doors installed in an interior or exterior of a public construction such as a school or public institution. That is, a break-resistant partition window or door can be provided by the application of the present invention, as contrary to the conventional reinforced glass which protects a human body from an incised wound and secures safety by breaking into fine splines when an impact is applied thereto. Also, the partition or window can be made more flame-retardant by increasing the amount of glass fibers contained in the composite material. Accordingly, the composite material of the present invention can serve as an effective partition which resists to breakage during an earthquake or similar disasters as well as prevents spread of a fire. Also, the composite material of the present invention can be made particularly high in transparency and excellent in design.

Where the visible light transmitting composite material is applied to electronic parts, its transparency allows an optical part to be directly laminated for arrangement in a substrate. Hence, instead of using the conventional method wherein a small-sized LED element is individually packaged and then mounted on a surface of the substrate, a method can be utilized which directly mounts and then laminates the element on the substrate. This eliminates the need of individual packaging, which permits arrangement of LEDs with a narrow spacing, for signal lamps, automobile indicator lamps, and large-sized and small-sized LED displays, so that their display capabilities are improved, enables a marked reduction of a mounting cost and achieves saving of members that is a significant contribution from an environmental point of view. Also in the case where the visible light transmitting composite material is applied to a photodevice, a light that passes through an organic substance is made available for receiving and transmitting signals, as contrary to the conventional practice wherein transmission and receipt of signals between superimposed boards are electrically achieved by a single line that extends through a through-hole between them. Accordingly, the simultaneous and high-speed receipt and transmission of a multiple signal in a multi-range can be realized by a single device. Also, the use of the visible light transmitting composite material for such a device enables reduction in size of the substrate as a result of material saving as well as reduction in number of processes, which is desirable from an environmental point of view.

As a flat display of an image display device represented as by a liquid crystal display and a plasma display, a sheet glass is used which comprises various types of special materials commensurate with a device having superior optical properties and high quality level of appearance. Also, the spread of various information terminal devices such as PDA, represented by a mobile telephone, has accelerated development of image display modes and activated research and development directed to an information infrastructure of a next generation. In the case where the present invention is the visible light transmitting composite material, the transparent composite material using glass fibers can be mounted in the image display device as an alternative of the sheet glass mounted in the image display device.

The above composite material of the present invention, if additionally in the form of a sheet mounted in a flat display device, has optical properties required for the flat display device and a low density sufficient to construct a light-weight flat display device, which is desirable. Also, it accelerates development toward various flat displays, which conventional sheet glasses have been difficult to realize, promotes further research and development and is an essential measure to produce a display device having higher functions.

The sheet mounted in a flat display device, as described above, refers to a flat member which constitutes an image display portion of a display device for displaying images, such as a liquid crystal display, plasma display, SED and FED.

The aforesaid visible light transmitting composite material in accordance with the present invention is also useful in applications other than the flat display and other preceding applications, unless it constitutes a hindrance in terms of strength and optical performances. Examples of useful applications include a substrate glass for solar cell, a cover glass for solid image pickup device, a cover glass for LED and a cover glass for SAW filter.

### EFFECT OF THE INVENTION

(1) Because the composition for glass fiber in accordance with the present invention comprises, by mass in terms of oxide, 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO₂ and 0-10% of ZrO₂, it is highly matched in optical constants with a transparent resin, exhibits a high affinity for the resin, exhibits good adhesion to the resin and shows superior melt properties and spinnability in the process of glass production.

(2) If the composition for glass fiber in accordance with the present invention has optical constants represented by a refractive index (nd) in the range of 1.48-1.55 and an Abbe number (νd) in the range of 65-50, it is highly matched in the visible region with a transparent resin having a refractive index of 1.47-1.56, so that optical problems such as coloring can be avoided.

(3) If the amount (ΣR₂₀) of an alkali elution according to JIS R 3502 (1995) does not exceed 0.35 mg for the composition for glass fiber in accordance with the present invention, the glass fiber and the organic resin can be combined with high productivity and the resulting combination little changes with time, i.e., shows highly stable durability.

(4) If a forming temperature (Tx) corresponding to the 10³ dPa·s viscosity of a molten glass does not exceed 1,400° C. for the composition for glass fiber in accordance with the present invention, problematic forming failure can be suppressed during production of glass fibers and a serviceable period of glass fiber production facilities can be extended.

(5) If the composition for glass fiber in accordance with the present invention exhibits a liquidus temperature (Ty) of not exceeding 1,300° C., precipitation of crystals that may plug nozzles or cut glass fibers can be suppressed. Also, the occurrence of defectives due to devitrification can be reduced.

(6) If the composition for glass fiber in accordance with the present invention shows at least 70° C. for the temperature difference (ΔTxy) between the forming temperature (Tx) and the liquidus temperature (Ty), it can be readily formed into glass fibers of various sizes in a stable condition and thus successfully supplies glass fiber products commensurate with the particular demands of customers.

(7) Because the glass fiber of the present invention is formed from the aforesaid glass composition for glass fiber, it can achieve a high transmittance in the visible wavelength region by coating an optimum agent selected depending on the material type of the resin to be combined.

(8) Because the process for producing a glass fiber, in accordance with the present invention, includes the steps of melting the aforesaid glass composition for glass fiber in a heat-resisting container and then continuously drawing a molten glass through a heat-resisting nozzle to thereby form a glass fiber, coating a surface of the glass fiber with an agent, and continuously winding up the coated glass fiber in a roll configuration, glass fiber products with a superb quality level can be produced with high efficiency. Also, an abundant supply thereof contributes to production of a visible light transmitting composite material having superior functions.

(9) Because the composite material of the present invention is obtained by combining the aforesaid glass fiber of the present invention with an organic resin material, it exhibits superior properties of the organic resin material as well as lightweight properties and strength properties of the glass fiber.

### BRIEF DESCRIPTION OF THE DRAWINGS

FIG. 1 shows a transmittance curve for the glass composition for glass fiber (example sample No. 13) in accordance with the present invention.

FIG. 2 shows a transmittance curve for the other glass composition for glass fiber (example sample No. 14) in accordance with the present invention.

### BEST MODE FOR CARRYING OUT THE INVENTION

The composition for glass fiber, glass fiber and a process for production thereof, in accordance with the present invention, are below described by way of examples.

### Example 1

The specifications of example compositions for glass fiber in accordance with the present invention, as well as evaluation results thereof, are shown in Tables 1 and 2. The glass compositions given in Tables 1 and 2 are expressed in % by mass in terms of oxide.

TABLE 1

| | Example | | | | | |
|---|---|---|---|---|---|---|
| | Sample No. | | | | | |
| | 1 | 2 | 3 | 4 | 5 | 6 |
| SiO₂ | 65.4 | 65.6 | 67.0 | 68.6 | 68.7 | 68.4 |
| Al₂O₃ | 8.5 | 7.6 | 5.0 | 6.5 | 6.5 | 6.9 |
| B₂O₃ | 10.2 | 10.0 | 10.0 | 9.0 | 9.0 | 9.0 |
| MgO | — | — | — | — | — | — |
| CaO | — | — | — | — | — | — |
| SrO | — | 0.5 | — | — | — | — |
| BaO | 1.6 | — | — | — | — | — |
| ZnO | 0.5 | 1.5 | 1.5 | 1.5 | 1.5 | 1.5 |
| MgO + CaO + SrO + BaO + ZnO | 2.1 | 2.0 | 1.5 | 1.5 | 1.5 | 1.5 |
| Li₂O | 5.2 | 4.2 | 5.0 | 2.9 | 1.8 | 1.9 |
| Na₂O | 7.6 | 7.6 | 7.5 | 4.5 | 4.5 | 3.7 |
| K₂O | 1.0 | 1.0 | 1.0 | 5.0 | 5.0 | 5.0 |
| Li₂O + Na₂O + K₂O | 13.8 | 12.8 | 13.5 | 12.4 | 11.3 | 10.6 |
| TiO₂ | — | 2.0 | 3.0 | 2.0 | 3.0 | 3.6 |
| ZrO₂ | — | — | — | — | — | — |
| Refractive Index nd | 1.512 | 1.525 | 1.532 | 1.516 | 1.514 | 1.515 |
| Abbe Number νd | 63 | 59 | 57 | 60 | 58 | 56 |
| Amount of | 0.07 | 0.06 | 0.08 | 0.03 | 0.03 | 0.02 |
| Alkali Elution [JIS R3502] | | | | | | |
| ΣR2O (mg) | | | | | | |
| Forming | 1041 | 1072 | 1028 | 1196 | 1278 | 1290 |
| Temperature Tx (° C.) | | | | | | |
| Liquidus | ≦900 | ≦900 | 890 | ≦940 | ≦940 | ≦940 |
| Temperature Ty (° C.) | | | | | | |
| Δxy = Tx − Ty (° C.) | ≧141 | ≧172 | ≧138 | ≧256 | ≧338 | ≧350 |
| Glass Fiberization | ◯ | ◯ | ◯ | ◯ | ◯ | ◯ |
| | Example | | | | | |
| | Sample No. | | | | | |
| | 7 | 8 | 9 | 10 | 11 | 12 |
| SiO₂ | 67.5 | 70.5 | 68.5 | 74.0 | 66.0 | 69.0 |
| Al₂O₃ | 2.0 | 5.5 | 8.5 | 3.0 | 6.5 | 5.4 |
| B₂O₃ | 17.5 | 10.0 | 10.5 | 15.0 | 6.0 | 11.0 |
| MgO | — | 1.0 | — | — | 1.7 | — |
| CaO | — | 1.5 | — | — | 2.0 | 0.5 |
| SrO | — | — | — | — | — | — |
| BaO | — | — | — | — | — | 2.5 |
| ZnO | — | — | 2.0 | — | 1.5 | 1.0 |
| MgO + CaO + SrO + BaO + ZnO | 0.0 | 2.5 | 2.0 | 0.0 | 5.2 | 4.0 |
| Li₂O | — | — | 4.0 | — | 1.8 | — |
| Na₂O | 2.0 | 6.0 | 6.5 | 6.0 | 4.5 | 8.5 |
| K₂O | 6.5 | 2.5 | | 2.0 | 5.0 | 2.1 |
| Li₂O + Na₂O + K₂O | 8.5 | 8.5 | 10.5 | 8.0 | 11.3 | 10.6 |
| TiO₂ | 4.5 | 3.0 | — | — | — | — |
| ZrO₂ | — | — | — | — | 5.0 | — |
| Refractive Index nd | 1.505 | 1.512 | 1.511 | 1.486 | 1.535 | 1.506 |
| Abbe Number νd | 54 | 55 | 63 | 64 | 54 | 63 |
| Amount of | 0.25 | 0.04 | 0.03 | 0.05 | 0.04 | 0.06 |
| Alkali Elution [JIS R3502] | | | | | | |
| ΣR2O (mg) | | | | | | |
| Forming | 1230 | 1350 | 1143 | 1305 | 1221 | 1230 |
| Temperature Tx (° C.) | | | | | | |
| Liquidus | 950 | 975 | ≦940 | ≦940 | ≦940 | ≦940 |
| Temperature Ty (° C.) | | | | | | |
| Δxy = Tx − Ty (° C.) | 280 | 375 | ≧203 | ≧281 | ≧281 | ≧290 |
| Glass Fiberization | ◯ | ◯ | ◯ | ◯ | ◯ | ◯ |

TABLE 2

| | Sample No. | | | | | |
|---|---|---|---|---|---|---|
| | 13 | 14 | 15 | 16 | 17 | 18 |
| SiO₂ | 68.0 | 66.0 | 66.0 | 70.3 | 65.5 | 64.6 |
| Al₂O₃ | 6.5 | 5.5 | 5.5 | 5.5 | 3.5 | 6.3 |
| B₂O₃ | 9.0 | 8.0 | 8.0 | 9.5 | 5.5 | 5.0 |
| MgO | — | 1.0 | — | — | — | 2.1 |
| CaO | — | 1.9 | — | 0.5 | 1.1 | 0.8 |
| SrO | — | — | — | 1.0 | 1.3 | 1.8 |
| BaO | — | — | — | 1.0 | 1.2 | 2.2 |
| ZnO | 1.5 | 3.0 | 5.1 | 1.5 | 2.5 | 0.5 |
| MgO + CaO + SrO + BaO + ZnO | 1.5 | 5.9 | 5.1 | 4.0 | 6.1 | 7.4 |
| Li₂O | 2.5 | 2.9 | 2.9 | 1.7 | 1.7 | 2.9 |
| Na₂O | 4.5 | 4.5 | 4.5 | 4.0 | 8.5 | 5.6 |
| K₂O | 5.0 | 5.0 | 5.0 | 4.5 | 3.7 | 2.2 |
| Li₂O + Na₂O + K₂O | 12.0 | 12.4 | 12.4 | 10.2 | 13.9 | 10.7 |
| TiO₂ | 3.0 | 2.2 | 3.0 | 0.5 | 3.5 | 6.0 |
| ZrO₂ | — | — | — | — | 2.0 | — |
| Refractive Index nd | 1.519 | 1.526 | 1.526 | 1.507 | 1.544 | 1.549 |
| Abbe Number νd | 58 | 58 | 58 | 63 | 60 | 55 |
| Amount of | 0.04 | 0.06 | 0.05 | 0.03 | 0.07 | 0.05 |
| Alkali Elution [JIS R3502] | | | | | | |
| ΣR2O (mg) | | | | | | |
| Forming | 1209 | 1170 | 1198 | 1249 | 1117 | 1163 |
| Temperature Tx (° C.) | | | | | | |
| Liquidus | ≦940 | ≦900 | ≦900 | ≦1100 | ≦940 | ≦1000 |
| Temperature Ty (° C.) | | | | | | |
| Δxy = Tx − Ty (° C.) | ≧269 | ≧270 | ≧298 | ≧149 | ≧177 | ≧163 |
| Glass Fiberization | ◯ | ◯ | ◯ | ◯ | ◯ | ◯ |

All the glass samples from the sample No. 1 to the sample No. 18 are prepared according to the following procedure and then evaluated.

Plural glass raw material components including natural raw material components and synthetic raw material components were weighed to their respective amounts in accordance with the specified composition and mixed to prepare a batch consisting of a homogeneous mixture of glass raw material components, which was then introduced in a platinum-rhodium crucible. This platinum-rhodium crucible containing the batch was subsequently heated in an ambient atmosphere in an indirect electric heating furnace at 1,550° C. for 5 hours to allow the mixed raw material batch to undergo a high-temperature chemical reaction into a molten glass. In the course of being thermally melted, the molten glass was brought to a homogeneous state by stirring using a heat-resisting stirring bar.

The molten glass in the homogeneous state was poured into a specific heat-resisting mold for cast molding and then annealed in an annealing furnace to obtain a final glass product.

The example glass compositions in accordance with the present invention were each measured for various physical properties according to the following procedure. The results are collectively shown in Table 1.

For the measurement of refractive index, each glass product was placed in a temperature-controllable electric furnace where it is heat treated at a temperature 30-50° C. higher than a temperature corresponding to 10¹³ dPa·s, called an annealing point, for 30 minutes, cooled at a rate of 1° C. per minute from the annealing point to a temperature corresponding to 10^{14.5} dpa·s, called a strain point, and finally cooled to a room temperature. Thereafter, the glass product was cut into a form of a V block and then polished with an abrasive. Using a precise refractometer manufactured by Kalnew Optical Industrial Co., Ltd., each glass product while maintained at room temperature was measured for refractive index relative to a spectral line (D line) at a wavelength of 587.56 nm from the He light source, refractive index (nF) relative to a spectral line (F line) at a wavelength of 486.13 nm from the H light source and refractive index (nC) relative to a spectral line (C line) at a wavelength of 656.27 nm from the H light source. The Abbe number (νd) was calculated from the measurement results for those refractive indices by the above equation. The glass product in the form of a glass fiber can be determined by the Becke line method (JIS K 7142 B method) using two types of certified refractive index liquids and a polarizing microscope or the like.

For measurement of the forming temperature (Tx) corresponding to the 10³ dPa·s viscosity of the molten glass, each glass product was shattered to a proper size, introduced in an alumina crucible while avoiding incorporation of air bubbles as much as possible, and reheated to a melt state. The glass product while in the melt state was measured several times for viscosity by a platinum ball pull-up method to generate a viscosity curve. The forming temperature was determined by interpolating the obtained viscosity curve.

For measurement of the liquidus temperature (Ty), each glass product was milled to a predetermined particle size. Classification was subsequently carried out to remove fine products and control the particle size of the glass powder to fall within the range from 300 μm to 500 μm so that a surface area of the glass powder fell within the predetermined range. This milled glass with the controlled particle size was filled in a platinum container while keeping a proper bulk density and then placed in an indirect heating type temperature gradient furnace that set a maximum temperature at 1,250° C., where it was allowed to stand while heated continuously under a normal pressure in the ambient atmosphere for a period of 16 hours. Thereafter, the test specimen, together with the platinum container, was removed from the furnace, cooled to a room temperature and immersed in a immersion liquid where a precipitation temperature of crystals, i.e., the liquidus temperature (Ty) was specified using a polarizing microscope.

The category “glass fiberization”, as listed in the Tables, indicates evaluation results for spinnability of the glass products. The evaluation was made according to the following procedure. Each glass product was melted and then spun at a spinning temperature into filaments through plural small-sized platinum nozzles. The resulting 11 μm diameter glass filaments were sized to provide a glass fiber. The rating of x was denoted if the glass fiber experienced breakage due to devitrification and glass fiberization was interrupted, while the rating of ◯ was denoted if no fiber breakage occurred during the glass fiberizing operation and no devitrified substance was observed.

As evidenced from the preceding tests, all the example samples in accordance with the present invention, sample Nos. 1 through 18, contain SiO₂ in the range from 65.4% to 74%, Al₂O₃ in the range from 2.0% to 8.5%, B₂O₃ in the range from 5.0% to 17.5%, Li₂O+Na₂O+K₂O in the range from 8.0% to 13.9%, MgO+CaO+SrO+BaO+ZnO in the range of not exceeding 7.4%, TiO₂ in the range of not exceeding 6.0% and ZrO₂ in the range of not exceeding 5.0%, all the percentages being by mass in terms of oxide, and exhibit optical constants including the refractive index (nd) within the range from 1.486 to 1.549 and the Abbe number within the range from 54 to 64. They also exhibit the amount of alkali elution (ΣR₂O mg) within the range from 0.02 mg to 0.25 mg, the forming temperature (Tx) within the range from 1,028° C. to 1,350° C., the liquidus temperature (Ty) within the range from 900° C. to 1,100° C., and ΔTxy or Tx−Ty of at least 138° C. All the samples were found to have properties suitable as the glass fiber composition of the present invention.

Particularly characteristic samples, among the example samples in accordance with the present invention, are described below.

The glass composition of the example sample No. 1 exhibits a refractive index (nd) of 1.512 and an Abbe number of 63 and accordingly satisfies the requirements of the present invention. Also, the glass composition of the sample No. 1 shows the amount of alkali elution (ΣR₂O mg) of 0.07 mg. Further, the glass composition of the sample No. 1 exhibits a forming temperature (Tx) of 1,041° C. and a liquidus temperature (Ty) of not exceeding 900° C. The liquidus temperature was low to the extent that prevented the inventors of this application from specifying it by the test. Hence, a value for ΔTxy or Tx−Ty is estimated to be at least 141° C., which was evaluated as being sufficient to establish stable forming conditions. This glass product was evaluated for glass fiberization. The results demonstrated that the glass product was successfully spun into homogeneous glass fibers without the occurrence of a problem of devitrification or the like and denoted the rating of ◯.

The glass composition of the example sample No. 4 exhibits a refractive index (nd) of 1.516 and an Abbe number of 60 and accordingly has optical constants required for the present invention. Also, the glass composition of the sample No. 4 shows superior properties by the amount of alkali elution (ΣR₂O mg) of 0.03 mg. Further, the glass composition of the sample No. 4 exhibits a forming temperature (Tx) of 1,196° C. and a liquidus temperature (Ty) of not exceeding 940° C. Hence, a value for ΔTxy or Tx−Ty is estimated to be at least 256° C., which was evaluated as being sufficiently large to establish stable forming conditions. This glass product was evaluated for glass fiberization. The results showed that the glass product was successfully spun into homogeneous glass fibers without the occurrence of a problem of devitrification or the like, as similar to the sample No. 1, and denoted the rating of ◯.

The example sample No. 6 exhibits a refractive index of 1.515 and an Abbe number of 56 and accordingly satisfies the requirements of the present invention. Also, it shows the amount of alkali elution (ΣR₂O mg) of 0.02 mg, which value is the smallest and demonstrated a particularly high performance in chemical durability. Further, the glass of the sample No. 6 exhibited a forming temperature (Tx) of 1,290° C. and a liquidus temperature (Ty) of not exceeding 940° C. Hence, a value for ΔTxy or Tx−Ty is estimated to be at least 350° C., which value is the largest in this respect. Good and satisfactory results were obtained for glass fiberization and the rating of ◯ was denoted.

The example sample No. 13 exhibits a refractive index of 1.519 and an Abbe number of 58 and accordingly satisfies the requirements of the present invention. Also, it showed the amount of alkali elution (ΣR₂O mg) of 0.04 mg and demonstrated a satisfactory performance in chemical durability. Further, the glass of the sample No. 13 glass exhibited a low forming temperature (Tx) of 1,209° C. and a liquidus temperature (Ty) of not exceeding 940° C. Hence, a value for ΔTxy or Tx−Ty is estimated to be at least 269° C., which is a large value. Good and satisfactory results were obtained for glass fiberization and the rating of ◯ was denoted.

The example sample No. 14 exhibits a refractive index of 1.526 and an Abbe number of 58 and accordingly satisfies the requirements of the present invention, as similar to the other samples. Also, it showed the amount of alkali elution (ΣR₂O mg) of 0.06 mg and demonstrated a satisfactory performance in chemical durability. Further, the glass of this sample No. 14 exhibited a low forming temperature (Tx) of 1,170° C. and a liquidus temperature (Ty) of not exceeding 900° C. Hence, a value for ΔTxy or Tx−Ty is estimated to be at least 270° C., which is a satisfactory value. Good and satisfactory results were obtained for glass fiberization and the rating of ◯ was denoted.

The operation used in the Example in accordance with the present invention was followed to prepare samples of Comparative Examples. Table 3 follows the form prescribed in the Example to list glass compositions and evaluation results for comparative samples, Nos. 101 through 104.

TABLE 3

| | Comparative Example | | | |
|---|---|---|---|---|
| | Sample No. | | | |
| | 101 | 102 | 103 | 104 |
| SiO₂ | 56.5 | 75.5 | 65.0 | 70.3 |
| Al₂O₃ | 13.5 | 0.3 | 25.0 | 2.0 |
| B₂O₃ | 8.0 | 19.6 | — | 1.0 |
| MgO | — | 0.4 | 10.0 | 3.6 |
| CaO | 22.0 | 0.6 | — | 5.5 |
| SrO | — | — | — | — |
| BaO | — | — | — | — |
| ZnO | — | — | — | — |
| MgO + CaO + SrO + | 22.0 | 1.0 | 10.0 | 9.1 |
| BaO + ZnO | | | | |
| Li₂O | — | 0.9 | — | — |
| Na₂O | — | 1.6 | — | 16.3 |
| K₂O | — | 1.1 | — | 1.3 |
| Li₂O + Na₂O + K₂O | 0.0 | 3.6 | 0.0 | 17.6 |
| TiO₂ | — | — | — | — |
| ZrO₂ | — | — | — | — |
| Refractive Index nd | 1.561 | 1.474 | 1.525 | 1.514 |
| Abbe Number νd | 56 | 68 | 62 | 57 |
| Amount of | 0 | 0.26 | 0 | 0.9 |
| Alkali Elution [JIS | | | | |
| R3502] ΣR2O (mg) | | | | |
| Forming | 1200 | 1345 | 1470 | 1160 |
| Temperature Tx (° C.) | | | | |
| Liquidus | 1050 | ≦940 | 1445 | ≦940. |
| Temperature Ty (° C.) | | | | |
| Δxy = Tx − Ty (° C.) | 150 | ≧405 | 25 | 220 |
| Glass Fiberization | ◯ | ◯ | X | ◯ |

The glass of the comparative example sample No. 101 has a similar composition to the so-called E glass. Because this glass is an alkali-free glass, it is not applicable to the composition for glass fiber in accordance with the present invention. This sample No. 101 exhibits a refractive index (nd) of 1.561 and thus does not satisfy the requirement of the present invention that is 1.55 or below. Although its Abbe number is 56, the excessively high refractive index makes the sample unsuited for combination with a resin having a refractive index of less than 1.55. A composite material formed by combining the sample and such a transparent resin is not desirable because it fails to exhibit a high transmittance over the entire visible wavelength region.

The comparative example sample No. 102 exhibits an SiO₂ content of 75.5% by mass and accordingly does not satisfy the requirement of the present invention. Also, a total amount of Li₂O+Na₂O+K₂O, i.e., a total amount of alkali metal elements is 3.6% by mass in terms of oxide, which is a low value. As a result, the refractive index marks 1.474 which value falls far below the refractive index range of 1.48 as required by the present invention. Also, the Abbe number of 68 falls outside the range from 65 to 50. Therefore, the number of transparent resins applicable for combination with this glass is small, which makes the sample No. 102 unsuited for the present invention.

The comparative example sample No. 103 shows good results regarding alkali elution. However, it exhibits a forming temperature (Tx) of 1,470° C., a liquidus temperature (Ty) of 1,445° C. and a ΔTxy value of 25° C. as calculated by Tx−Ty. This ΔTxy value of lower than 70° C. increases a tendency of crystalline substances to precipitate in a molten glass during a spinning operation and increases the concern for inadequate glass fiberization when the produced crystalline foreign substances causes breakage. Evaluation of glass fiberization substantiated the concern and denoted the rating of x.

The comparative example sample No. 104 contains Li₂O+Na₂O+K₂O in the amount of 17.6% which value is excessively high. Accordingly, the amount of alkali elution (ΣR₂O mg) increases to 0.09 mg. This increased the concern for problems that may occur during or after formation of a composite material.

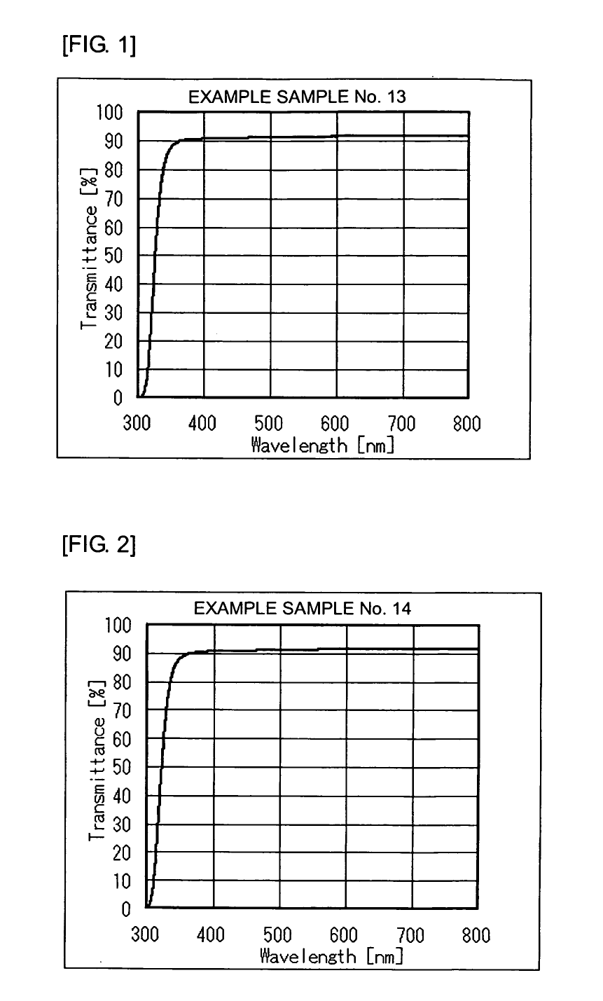

The sample Nos. 1, 3, 13 and 14, among the example samples in accordance with the present invention, were measured for transmittance in the following fashion. Each glass product obtained via cast molding of a molten glass was ground down and polished at its opposite surfaces for mirror finish to provide a test specimen having a 25 mm×30 mm, light transmitting surface and a thickness of 1 mm. The test specimen was measured for light transmittance at a wavelength ranging from 300 nm to 800 nm using UV-3100PC manufactured by Shimadzu Corporation. The light transmittance at a wavelength of 300 nm or higher by intervals of 50 nm at a thickness of 1.0 mm is shown in Table 4. The transmittance curves for the sample Nos. 13 and 14, representative of the Example, are shown in FIGS. 1 and 2.

TABLE 4

| | | Ex. | | | | Comp. Ex. | |
|---|---|---|---|---|---|---|---|
| Sample No. | | 1 | 3 | 13 | 14 | 101 | 106 |
| Transmittance | Wavelength 800 (nm) | 91.3 | 91.5 | 91.5 | 91.5 | 84.0 | 87.0 |
| [%, at 1 mm thickness] | 750 | 91.3 | 91.5 | 91.5 | 91.4 | 85.3 | 87.6 |
| | 700 | 91.4 | 91.5 | 91.5 | 91.5 | 86.4 | 88.1 |
| | 650 | 91.5 | 91.5 | 91.5 | 91.5 | 87.2 | 88.5 |
| | 600 | 91.5 | 91.5 | 91.4 | 91.5 | 88.0 | 88.4 |
| | 550 | 91.4 | 91.3 | 91.3 | 91.4 | 88.5 | 87.3 |
| | 500 | 91.4 | 91.1 | 91.2 | 91.2 | 87.9 | 83.9 |
| | 450 | 91.2 | 90.7 | 90.9 | 90.9 | 85.8 | 77.6 |
| | 400 | 91.1 | 90.3 | 90.6 | 90.7 | 80.9 | 71.9 |
| | 350 | 90.3 | 87.3 | 87.4 | 88.2 | 26.1 | 65.2 |
| | 300 | 76.9 | 0.0 | 0.0 | 0.1 | 0.0 | 0.0 |

| | | | | | | |
|---|---|---|---|---|---|---|
| $\frac{\begin{matrix}Transmittance Value \\ at 750 nm Wavelength\end{matrix}}{\begin{matrix}Transmittance Value \\ at 350 nm Wavelength\end{matrix}} = 750 Standard Transmittance Ratio$ | 1.01 | 1.05 | 1.05 | 1.04 | 3.27 | 1.33 |
| $\frac{\begin{matrix}Transmittance Value \\ at 550 nm Wavelength\end{matrix}}{\begin{matrix}Transmittance Value \\ at 350 nm Wavelength\end{matrix}} = 550 Standard Transmittance Ratio$ | 1.01 | 1.05 | 1.04 | 1.04 | 3.39 | 1.34 |

As can be clearly seen from this Table 4, the sample Nos. 1, 3, 13 and 14 each comprising the glass composition for glass fiber in accordance with the present invention exhibit a light transmittance at a wavelength from 800 nm to 350 nm of exceeding 80%. They exhibit high transmittance, regardless of the particular wavelength of a light. This is also clear from the data that the 750 standard transmittance ratio obtained by dividing a transmittance at 750 nm by a transmittance at 350 nm as well as the 550 standard transmittance ratio obtained by dividing a transmittance at 550 nm by a transmittance at 350 nm are both within the range of 0.8-1.2. Where a visible light absorption is observed at a specific wavelength along the transmittance curve for the glass, these standard transmittance ratios are affected such that their values fall outside the range of 0.8-1.2. For example, the comparative example sample No. 101 having an E glass composition was melted and processed in the same manner as in the Example into a 1 mm thick, mirror finished sheet glass, similar to those example samples, and measured for transmittance. Due to the high inclusion of an Fe (iron) component in the E glass, absorption appears in the ultraviolet region and accordingly reduces a light transmittance at a wavelength of 350 nm. As a result, both the 750 and 350 standard transmittance ratios exceed 1.2. The sample No. 106 having an AR glass composition was similarly processed and measured for transmittance. Also in this case, absorption of a light in the ultraviolet region hinders linearity of a transmittance curve. So, the 750 and 350 standard transmittance ratios both fall outside the range of 0.8-1.2. Because these glasses exhibit a low transmittance for a light in a shorter wavelength portion of the visible region, necessary optical corrections must be made in order for them to be used as a visible light transmitting material. This in some cases places a large obstacle in the formation of a high transmittance composite material. Therefore, these glasses are not desirable.

The preceding series of evaluation made in the Example and Comparative Example have clearly demonstrated that the glass composition for glass fiber in accordance with the present invention has optimum optical constants for combination with a transparent resin, represented by a refractive index of 1.47-1.56, as well as high forming properties during production, prevents the occurrence of devitrification or other problems during production and provides glass fibers with a high quality level.

### Example 2

The following illustrates a process for producing the glass composition for glass fiber in accordance with the present invention as practiced using a large-sized glass-melting furnace.

Various glass raw material components are weighed and mixed together to prepare a raw mix batch having the same composition as the sample No. 6 in Examples. This raw mix batch is continuously introduced in a glass-melting furnace by a charger for glass raw material. The introduced glass raw material is heated in the glass-melting furnace to a high temperature, 1,300° C. or above, so that it undergoes a vitrifying reaction into a molten glass.

The subsequent homogenizing operation such as stirring causes the molten glass to exit a melting process and flow into a platinum alloy bushing disposed in a forming zone of the glass-melting furnace. This bushing is provided with a number of properly temperature-controlled heat-resisting nozzles through which glass fibers are continuously withdrawn. The glass fibers are then quenched and coated at surfaces with an agent containing a coupling agent and the like by an applicator.

The glass fibers coated with the agent are thereafter wound around a paper tube attached to a turret winder. Plural glass fiber strands from the thus-obtained cakes are disentangled, arranged properly while being twilling and then wound around a bobbin into a roll configuration.

The thus-obtained glass fibers are transferred into a temperature-controllable electric furnace where they are heat treated at a temperature 30-50° C. higher than a temperature corresponding to 10¹³ dPa·s, called an annealing point, for 30 minutes, cooled at a rate of 1° C. per minute from the annealing point to a temperature corresponding to 10^{14.5} dPa·s, called a strain point, thereby achieving annealing, and finally cooled to a room temperature. Thereafter, the glass fibers are measured for refractive index by the Becke line method using two types of certified refractive index liquids, so that confirmation can be made if the measured value conforms to the refractive index value of the sample No. 6 as shown in Table 1. Because glass fibers are formed via quenching of a molten glass, they usually exhibit a lower refractive index (nd) than annealed glass. The reduction in value of refractive index (nd) varies depending on the particular production process. It is possible that the glass fibers exhibit a refraction index about 0.005-0.015 lower than when accompanied by annealing under the above conditions. However, the reduction in value of refractive index (nd) little changes when the conditions of the production process are consistent. Accordingly, provision of two types of liquids commensurate with the production process may be sufficient. A difference in refractive index of the glass fibers having the same glass composition as the example sample No. 6 prior to and subsequent to annealing under the above conditions was 0.010 when determined from comparison of their respective refractive index measurements. As a result, the glass fibers were confirmed to exhibit a lower value than when accompanied by annealing.

The preceding series of processes result in production of the glass fibers of the present invention. In this way, stable production of glass fibers having a high quality level can be achieved efficiently.

Next, the glass fibers unwound from the roll are weaved as warps and fillings into a plain cloth in which a cyclic olefin resin having optical constants represented by a refractive index (nd) of 1.515 and an Abbe number (νd) of 56 is impregnated to provide a transparent substrate having a thickness of 0.5 mm, a longitudinal dimension of 500 mm and a transverse dimension of 500 mm. The glass fiber and the resin material in the thus-obtained transparent substrate are well matched in optical constants, such as a refractive index and an Abbe number, with each other. Also, the transparent substrate exhibits a high transmittance, has high strength and is a lightweight structure. Accordingly, this transparent substrate is suitable as a transparent substrate for image display devices such as a liquid crystal display.

1. A glass composition for glass fiber characterized in that it comprises, by mass in terms of oxide, 60-75% of SiO₂, 0-10% of Al₂O₃, 0-20% of B₂O₃, 5-15% of Li₂O+Na₂O+K₂O, 0-10% of MgO+CaO+SrO+BaO+ZnO, 0-10% of TiO2 and 0-10% of ZrO₂.

2. A glass composition for glass fiber characterized in that it comprises, by mass in terms of oxide, 60-75% of SiO2, 0-10% of Al₂O₃, 0-20% of B₂O₃, 0-9% of Na₂O, 5-14% of Li₂O+Na₂O+K₂O, 0-10% of MgO+CaO+SrO+BaO+ZnO, 0-10% of TiO2 and 0-5% of ZrO₂.

3. A glass composition for glass fiber characterized in that it comprises, by mass in terms of oxide, 60-75% of SiO₂, 0-10% of Al₂O₃, 0-20% of B₂O₃, 0-9% of Na₂O, 5-14% of Li₂O+Na₂O+K₂O, 0-8% of MgO+CaO+SrO+BaO+ZnO, 0-10% of TiO2 and 0-5% of ZrO₂.

4. The glass composition for glass fiber as recited in claim 1, characterized in that it has optical constants represented by a refractive index (nd) in the range of 1.48-1.55 and an Abbe number (νd) in the range of 65-50.

5. The glass composition for glass fiber as recited in claim 1, characterized in that the amount of alkali elution (ΣR₂O mg) according to JIS R 3502 (1995) does not exceed 0.35 mg.

6. The glass composition for glass fiber as recited in claim 1, characterized in that a forming temperature (Tx) corresponding to the 10³ dPa·s viscosity of a molten glass does not exceed 1,400° C.

7. The glass composition for glass fiber as recited in claim 1, characterized in that a liquidus temperature (Ty) does not exceed 1,300° C.

8. The glass composition for glass fiber as recited in claim 1, characterized in that a temperature difference (ΔTxy) between the forming temperature (Tx) and the liquidus temperature is not less than 70° C.

9. A glass fiber characterized in that it comprises the glass composition as recited in claim 1.

10. A process for producing a glass fiber characterized in that it include the steps of melting the glass composition for glass fiber as recited in claim 1 in a heat-resisting container and then continuously drawing a molten glass through a heat-resisting nozzle to thereby form a glass fiber, coating a surface of the glass fiber with an agent, and continuously winding up the coated glass fiber in a roll configuration.

11. A composite material characterized in that it is obtained by combining the glass fiber as recited in claim 9 and an organic resin material.

12. The glass composition for glass fiber as recited in claim 2, characterized in that it has optical constants represented by a refractive index (nd) in the range of 1.48-1.55 and an Abbe number (νd) in the range of 65-50.

13. The glass composition for glass fiber as recited in claim 3, characterized in that it has optical constants represented by a refractive index (nd) in the range of 1.48-1.55 and an Abbe number (νd) in the range of 65-50.

14. The glass composition for glass fiber as recited in claim 2, characterized in that the amount of alkali elution (ΣR₂O mg) according to JIS R 3502 (1995) does not exceed 0.35 mg.

15. The glass composition for glass fiber as recited in claim 3, characterized in that the amount of alkali elution (ΣR₂O mg) according to JIS R 3502 (1995) does not exceed 0.35 mg.

16. The glass composition for glass fiber as recited in claim 2, characterized in that a temperature difference (ΔTxy) between the forming temperature (Tx) and the liquidus temperature is not less than 70° C.

17. The glass composition for glass fiber as recited in claim 3, characterized in that a temperature difference (ΔTxy) between the forming temperature (Tx) and the liquidus temperature is not less than 70° C.
